(19) United States
(12) Patent Application Publication
(10) Pub. No.: US 2007/0194676 A1
(43) Pub. Date: Aug. 23, 2007

(54) Light emitting apparatus and method for producing the same

(75) Inventors: Yuichiro Tanda, Tokyo (JP); Kazuya Ishihara, Tsuru-shi (JP); Yoshinori Tsubosaki, Minamitsuru-gun (JP)

Correspondence Address: BROWDY AND NEIMARK, P.L.L.C.;624 NINTH STREET, NW, SUITE 300, WASHINGTON, DC, 20001-5303, US

(73) Assignee: Citizen Electronics Co., LTD., Fujiyoshida-Shi (JP)

(21) Appl. No.: 11/708,124

(22) Filed: Feb. 20, 2007

(30) Foreign Application Priority Data
Feb. 20, 2006 (JP) P2006-042425

(51) Int. Cl. H01K 1/30

(52) U.S. Cl. 313/110

(57) ABSTRACT

A light emitting apparatus including a base (2) having electrodes (6a, 6b), an LED (4) mounted on the base and electrically connected through electrical connecting members to the electrodes, a translucent sealing resin (8) to seal the light emitting element, a wavelength conversion material (9) to convert at least one portion of light emitted from the light emitting element to a different wavelength and a precipitation-prevention agent (10) to reduce precipitation of the wavelength conversion material being contained in the sealing resin, the precipitation-prevention agent being capable of controlling an amount of the wavelength conversion material precipitated.

### CROSS-REFERENCE TO THE RELATED APPLICATION

This application is based on and claims priority from Japanese Patent Application No. 2006-042425, filed on Feb. 20, 2006, the disclosure of which is incorporated herein by reference in its entirety.

### BACKGROUND OF THE INVENTION

1. Field of the Invention

The present invention relates to a light emitting apparatus using a light emitting element, more specifically to a light emitting apparatus including a wavelength conversion material to convent a portion of a wavelength of light emitted from the light emitting element to a different wavelength and a method for producing the light emitting apparatus.

2. Description of Related Art

A light emitting diode element (hereinafter, referred to as LED) which is a compound semi-conductor has conventionally been widely used as a light emitting apparatus on account of its features of compactness and a long operating life. With the production of an LED made of a gallium nitride type compound semi-conductor or the like which is capable of emitting blue light, a field of application of the LED has increasingly expanded to include a color display, in addition, a color backlight device of a mobile phone or the like, a display installed in a vehicle and a high-brightness high-output emission device for illumination.

As an application product of the blue LED, there has been disclosed a light emitting apparatus capable of emitting white light in which an LED chip is sealed using a sealing resin which contains a fluorescent material for converting a wavelength of light (for reference, see Japanese Patent Application Publication No. 2005-64233, page 4 of the specification, and FIG. 1).

Hereinafter, the light emitting apparatus disclosed in Japanese Patent Application Publication No. 2005-64233 is explained with reference to FIG. 9A.

The conventional light emitting apparatus 50 shown in FIG. 9A includes a base 58, a pair of electrodes 53 provided on the base 58, an LED 51 to emit blue light or the like, a case 52 disposed to surround the LED 51 and a translucent sealing resin 54 which is made of epoxy material or the like and contained in the case 52. The LED 51 is die-mounted on one of the electrodes 53 through, for example, a conductive adhesive or solder and is connected through a wire 55 to the other of the electrodes 53. The sealing resin contains a fluorescent material 56 of a YAG type or the like as a wavelength conversion material and a precipitation-prevention agent 57 of silicon oxide or the like so that the LED 51 and the wire 55 and so on are physically and chemically protected.

Here, because precipitation of the fluorescent material 56 in the sealing resin 54 can be limited to a certain extent by inclusion of the precipitation-prevention agent 57 in the sealing resin 54, even if a fluorescent material 56 having high wavelength conversion efficiency and a large particulate diameter is used, the fluorescent material 56 is held in a uniformly dispersed state inside the sealing resin 54. This makes it difficult for light irregularities and other such poor functioning to occur.

As well as the above, there has been proposed, a light emitting apparatus in which an LED is covered by a glass layer, and the covered LED is further covered by a sealing resin (for reference, see Japanese Patent Application publication No. 11-251640, pages 5 and 6 of the specification, and FIG. 1).

In the light emitting apparatus disclosed in Japanese Patent Application publication No. 11-251640, the glass layer contains a fluorescent material to convert a wavelength of light, a dispersion agent to disperse the light, a binding agent to prevent cracking of the glass layer and a precipitation-prevention agent which is made of ceramic powder or the like to prevent precipitation of the fluorescent material. Covering of the LED with the glass layer makes it possible to achieve a high-reliability light emitting apparatus in which penetration to the LED by water or other harmful materials is prevented and deterioration of the LED and the fluorescent material are reduced.

However, the above-mentioned conventional light emitting apparatuses have the following problems.

FIG. 9B illustrates operation of the light emitting apparatus 50 disclosed in Japanese Patent Application Publication No. 2005-64233. For convenience of explanation, the wire 55 connecting the LED 51 to the electrode 53 as shown in FIG. 9A is omitted. In FIG. 9B, when a drive current is applied to the pair of electrodes 53 from outside, operation of the LED 61 commences and, for example, blue emission lights B1, B2 and B3 are emitted. The emission light B1 does not strike against any fluorescent material 56 or precipitation-prevention agent 57 and passes through the sealing resin 54 to be emitted to the outside. The emission light B2 strikes the fluorescent material 56a, causing the fluorescent material 56a to become excited and convert the wavelength to a different wavelength, so that yellow light E1 is emitted toward the outside.

Next, we consider the emission light B3 which strikes the precipitation-prevention agent 57a, is reflected and has its direction changed by this impact to becomes emission light B4. The emission light B4 then strikes the fluorescent material 56b, causing the fluorescent material 56b to become excited and convert the wavelength, so that yellow lights E2 and E3 are emitted. The yellow light E2 does not hit any other fluorescent material 56 or precipitation-prevention material 57 and passes through the sealing resin 54 to be emitted to the outside. On the other hand, the yellow light E3 strikes and is reflected on the precipitation-prevention agent 57b to become yellow light E4 having a different direction from the direction of the yellow light E3. The yellow light E4 then strikes the fluorescent material 56c. However, because the yellow light E4 already has its wavelength converted, the fluorescent material 56c is not excited. Therefore, a large portion of the yellow light E4 striking the fluorescent material 56c is blocked and not emitted to the outside.

Moreover, because the emission light B4 striking the fluorescent material 56b is the reflected light of the emission light B3, it is weaker than the emission light B3. In addition, because the emission light B4 reaches the fluorescent material 56b after being emitted from the LED 51 and reflected on the precipitation-prevention agent 57a, it is attenuated by a long optical path to become even weaker. Therefore, the yellow light E2 which is generated by excitation of the fluorescent material 56b through impact of the emission light B4 and emitted to the outside becomes a weak light. That is to say, when comparing the yellow light E1 emitted to the outside from the fluorescent material 56a which is excited by the direct impact of the emission light B2 emitted from the LED 51 with the yellow light E2 emitted to the outside from the fluorescent material 56b excited by the impact of the emission light B4 reflected on the precipitation-prevention agent 57a, it is clear that the yellow light E2 emitted to the outside will be weaker than the yellow light E1 emitted to the outside.

In this way, because the emission light from the LED 51 and the yellow light from the fluorescent material 56 are reflected diffusely by the precipitation-prevention agent 57 inside the sealing resin 54, there is a significant problem that the light emitted to the outside is weakened by the precipitation-prevention agent 57, and that the amount of light of emitted by the light emitting apparatus is reduced. In addition, it is known by way of experiment that a certain amount of precipitation of the fluorescent material 56 in a vicinity of the LED 51 results in high wavelength conversion efficiency. To achieve such high wavelength conversion efficiency it is necessary to adequately control an amount of the fluorescent material 56 precipitated. However, the precipitation-prevention agent 57 in the conventional light emitting apparatus merely disperses the fluorescent material 56 uniformly inside the sealing resin 54, and it is therefore not possible to adequately control the amount of the fluorescent material 56 precipitated.

Also, in the conventional light emitting apparatus disclosed in Japanese Patent Application publication No. 11-251640, there is a problem that the passage of the emission light from the LED is blocked by the ceramic powder contained in the sealing resin and which acts as the precipitation-prevention agent, thus reducing the amount of light emitted. Furthermore, as in the case of the light emitting apparatus 50 disclosed in Japanese Patent Application Publication 2005-64233, it is difficult to achieve a high wavelength conversion efficiency, because the amount of the fluorescent material precipitated in the vicinity of the LED cannot be adequately controlled.

### SUMMARY OF THE INVENTION

An objective of the present invention is to provide a plurality of light emitting apparatus with uniform high brightness and stable characteristics, in which an amount of a wavelength conversion material precipitated is adequately controlled to enhance wavelength conversion efficiency without light emitted from a light emitting element being blocked by a precipitation-prevention agent used for reducing precipitation of the wavelength conversion material.

To accomplish the above object, a light emitting apparatus according to one embodiment of the present invention includes a light emitting-element and a resin to seal the light emitting element.

A wavelength conversion material to convert at least one portion of light emitted from the light emitting element to a different wavelength and a precipitation-prevention agent to reduce precipitation of the wavelength conversion material are contained in the resin.

### BRIEF DESCRIPTION OF THE DRAWINGS

FIG. 1 is a perspective view showing a first embodiment of a light emitting apparatus according to the present invention.

FIG. 2 is an enlarged sectional view for explaining how emission takes place in the light emitting apparatus according to the present invention.

FIG. 3A is a sectional view showing a mounting process to fix an LED of the light emitting apparatus to a base.

FIG. 3B is a sectional view showing a mounting process to perform a wire-bonding of the LED.

FIG. 4A is an explanatory view showing a mixing process in which a wavelength conversion material and a precipitation-prevention material are mixed in a resin which is used to seal the LED according to the present invention.

FIG. 4B is an explanatory view showing a process to agitate the resin after mixing the wavelength conversion material and the precipitation-prevention material in the resin applied to the light emitting apparatus according to the present invention.

FIG. 5A is a sectional view showing a process in which the resin is applied to the light emitting apparatus according to the present invention.

FIG. 5B is a sectional view showing a heating process in which the light emitting apparatus according to the present invention is heated and the resin hardened.

FIG. 6A is a graph showing a relationship between a heating temperature for heating the light emitting apparatus according to the present invention and a change in viscosity of the resin.

FIG. 6B is a graph showing a relationship between a heating time for heating the light emitting apparatus according to the present invention and a change in viscosity of the resin.

FIG. 7A is a schematically sectional view showing a state in which a small amount of precipitation of the wavelength conversion material has occurred inside the resin in the light emitting apparatus according to the present invention.

FIG. 7B is a schematically sectional view showing a state in which an appropriate amount of precipitation of the wavelength conversion material has occurred inside the resin in the light emitting apparatus according to the present invention.

FIG. 7C is a schematically sectional view showing a state in which a large amount of precipitation of the wavelength conversion material has occurred inside the resin in the light emitting apparatus according to the present invention.

FIG. 8 is a perspective view showing a second embodiment of the light emitting apparatus according to the present invention.

FIG. 9A is a schematically sectional view showing a conventional light emitting apparatus.

FIG. 9B is an enlarged sectional view to explain operation of the conventional light emitting apparatus.

### DETAILED DESCRIPTION OF THE PREFERRED EMBODIMENTS

Preferred embodiments of the present invention will be explained in detail with reference to the accompanying drawings below.

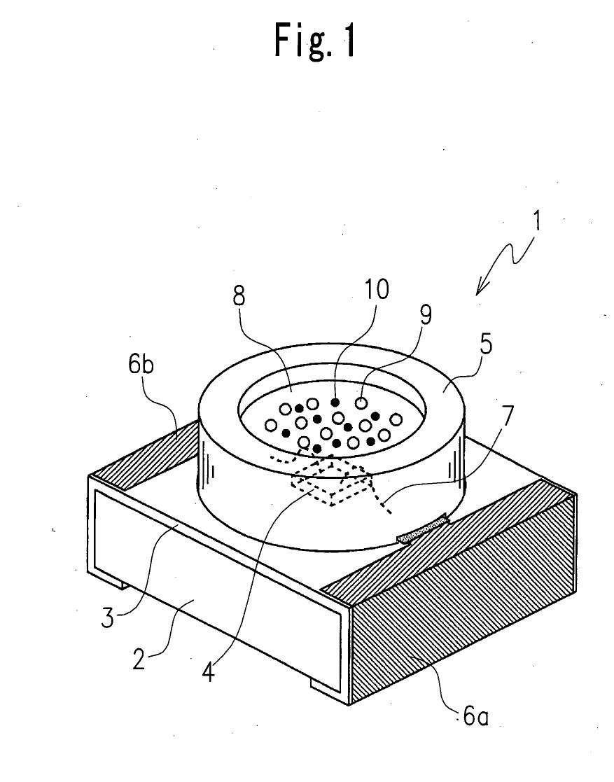

FIG. 1 illustrates a first embodiment of a light emitting apparatus according to the present invention.

The light emitting apparatus 1 in the first embodiment is realized as a high-brightness high-output type white light emitting apparatus. The light emitting apparatus 1 includes a base 2 which has a heat conducting capability. The base 2 has, for example, a generally rectangular solid-like shape and is preferably made of a metal material such as copper, aluminum or the like. Disposed on the base 2 is an insulative section 3 which is formed by an insulative epoxy material or the like to cover an upper surface, right and left side surfaces and a part of a lower surface of the base 2.

At least one LED 4 which acts as a light emitting element is die-mounted on the upper surface of the base 2 through a conductive adhesive (not shown) preferably with a heat conducting capability or solder.

Disposed on the insulative section 3 is a generally cylindrical cup 5 which has a heat conducting capability and is preferably made of an aluminum alloy material or the like having a high reflection coefficient. The cup 5 is disposed to surround the LED 4 and is fixed to the insulative section 3 through an adhesive or the like (not shown).

A pair of electrodes 6a and 6b each of which is formed by a copper foil or the like are provided on a surface of the insulative section 3. A part of the electrodes 6a and 6b is formed to be close to the LED 4 fixed on the upper surface of the base 2 and also to cover a portion of the right and left side surfaces and the lower surface of the base 2.

A pair of wires 7 each of which is an electrical connecting member are configured to electrically connect an anode terminal (not shown) and a cathode terminal (not shown) of the LED 4 to the electrodes 6a and 6b, respectively. It should be noted that the electrical connecting members to connect the LED 4 and the electrodes 6a, 6b are not limited to the wires 7, and the LED 4 may, for example, be connected to the electrodes through a face-down bonding system using soldering bumps or the like.

The cup 5 is filled with a resin or sealing resin 8 to seal the LED 4 and the wires 7. The sealing resin 8 is formed by an epoxy material or the like and protects the LED 4 and the wires 7 physically and chemically.

It should be noted that the LED 4 and the wires 7 are sealed here by filling the cup 5 with the sealing resin 8; however, the LED 4 and the wires 7 may be sealed directly with the sealing resin 8 without using the cup 5.

A fluorescent material 9 of YAG type functioning as a wavelength conversion material to convert a wavelength of light emitted from the LED 4 is contained in the sealing resin 8. It should be noted that any material, such as a fluorescent dye, fluorescent pigment, fluorescent substance or the like, may be used for the fluorescent material 9, as long as it is a material which converts the wavelength of the light from the LED 4 into another wavelength.

The precipitation-prevention agent 10 is made of a fatty acid amide and is contained in the sealing resin 8 together with the fluorescent material 9. It should be noted that the precipitation-prevention agent 10 starts to be affected by heat and to decrease its precipitation-prevention effect when the sealing resin 8 is heated and this is shown schematically for explanation herein. A temperature at which the precipitation-prevention agent 10 starts to be affected by heat, resulting in its composition being damaged by heat and its precipitation-prevention effect being decreased is mentioned as “an effect-starting-to-decrease temperature” here.

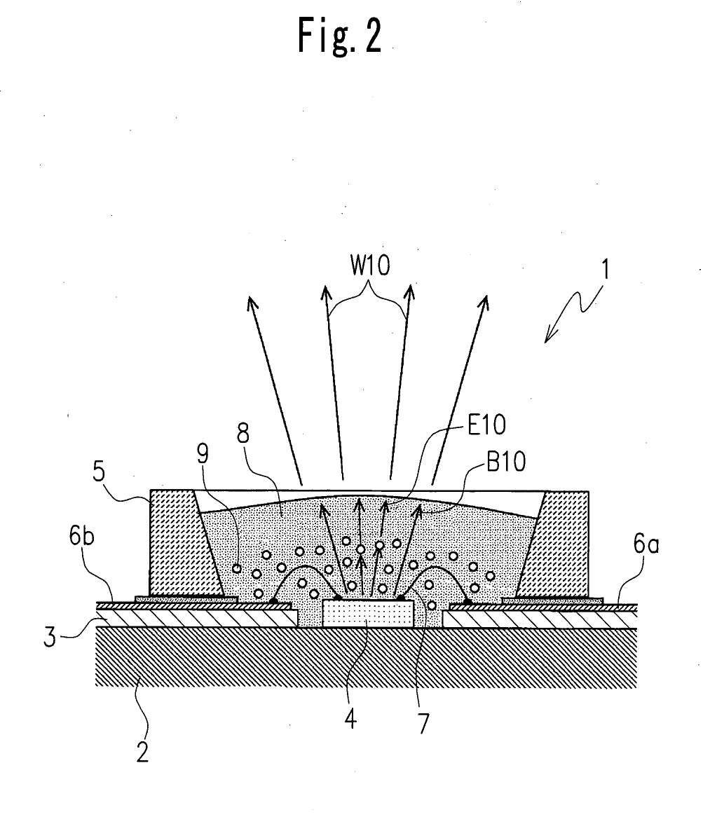

Next, operation of the light emitting apparatus according to the present invention is explained with reference to FIG. 2.

In FIG. 2, application of a drive voltage to the electrodes 6a and 6b in the light emitting apparatus 1 supplies a drive current to the LED 4 through the pair of wires 7. Thereby, operation of the LED 4 is commenced, and if the LED 4 is a blue LED for emission of blue light, the passing of a drive current through the LED 4 causes blue emission light B10 to be emitted from the LED 4.

Here, a part of the emission light B10 progresses through the sealing resin 8 and is emitted to the outside of the light emitting apparatus, and another part of the emission light strikes the fluorescent material 9 contained in the sealing resin 8. The fluorescent material 9 struck by the emission light B10 is excited and a wavelength conversion takes place so that yellow light E10 is emitted. Consequently, the emission light B10 which is emitted without any impacts against the fluorescent material 9 and the yellow light E10 which results from wavelength conversion after impacts against the fluorescent material 9 are mixed so that white light W10 appears to be emitted from the light emitting apparatus 1. The light emitting apparatus 1 thus acts as a white light emitter.

As mentioned above, the precipitation-prevention agent 10 is contained in the sealing resin 8. However, because the material of the precipitation-prevention agent 10 starts to be affected by heat and to decrease its precipitation-prevention effect when the sealing resin 8 is heated, the precipitation-prevention agent 10 allows the fluorescent material 9 to start precipitating so that appropriate precipitation of the fluorescent material 9 in each of a plurality of the apparatuses is achieved.

Operation of the precipitation-prevention agent 10 is explained below.

In the above-mentioned embodiment, although the blue LED has been used as the LED 4 and the YAG type material has been used as the fluorescent material 9 to emit the yellow light, the LED 4 and the fluorescent material 9 are not limited to the above-mentioned combination in the light emitting apparatus according to the present invention. For example, a fluorescent pigment or the like to convert light in various ways is used as the fluorescent material 9, and the emission light from the light emitting apparatus 1 is not limited to white light. The light emitting apparatus 1 may be structured to emit light of any desired color tone.

Alternatively, an LED to emit, for example, ultra-violet light may be used as the LED 4.

Next, a method for producing the light emitting apparatus according to the present invention is explained with reference to the accompanying drawings.

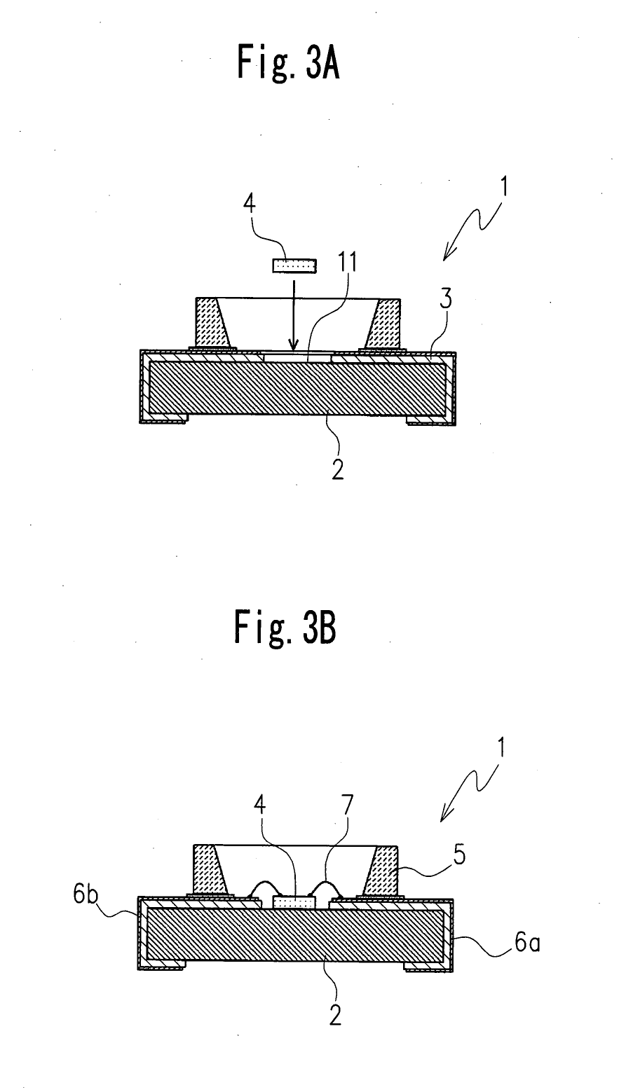

FIG. 3A illustrates a process for mounting the LED 4 on the base 2 in the light emitting apparatus 1 according to the present invention. In the mounting process, the LED 4 is die-mounted on a mounting area 11 from which the insulative section 3 has been removed to expose a surface of the base 2 through a conductive adhesive (not shown) with a heat conducting capability or solder (not shown). Thereby, even if heat is generated in the LED 4 by the drive current, the heat is efficiently transmitted to and released from the base 2.

Next, FIG. 3B illustrates a process for wire-bonding the LED 4 in the light emitting apparatus 1 according to the present invention.

In this process, the light emitting apparatus 1 is configured to electrically connect anode and cathode terminals (not shown) of the LED 4 to the electrodes 6a and 6b of the base 2 through a pair of wires 7 by use of a wire bonder (not shown) or the like, respectively. It should be noted that the cup 5 is fixed to the upper surface of the base 2 through an adhesive or the like so as to surround the LED 4, and that fixation of the cup 5 may be executed either before or after the mounting process of the LED 4.

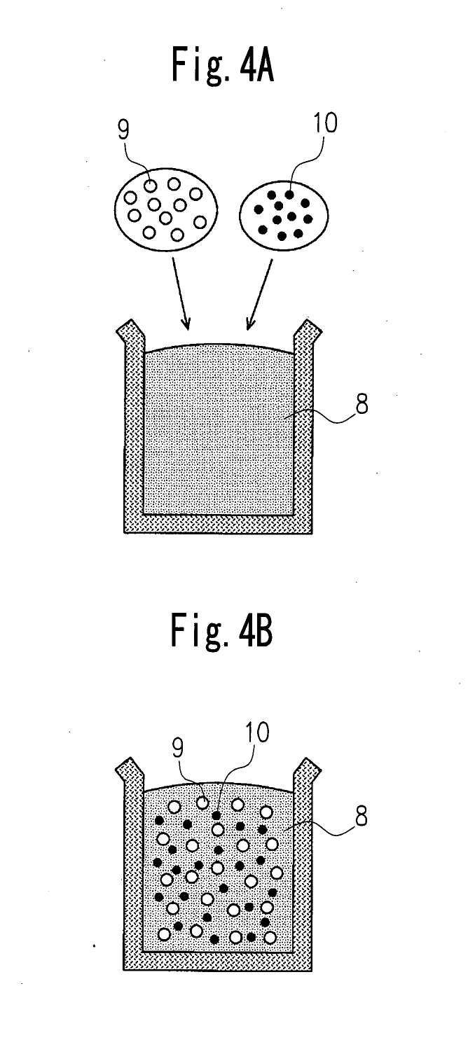

Next, FIG. 4A illustrates schematically a mixing process which allows mixing of the fluorescent material 9 and the precipitation-prevention agent 10 in the sealing resin 8 which is applied to the light emitting apparatus 1 according to the present invention.

In this process, the YAG type fluorescent material 9 and the fatty acid amide type precipitation-prevention agent 10 with a predetermined melting point are mixed, respectively, in a predetermined ratio, in the sealing resin 8 formed by the epoxy material or the like. It should be noted that a cure temperature of the sealing resin 8 is preferably is set at a temperature higher than the effect-starting-to-decrease temperature of the precipitation-prevention agent 10.

Next, FIG. 4B illustrates schematically a process to agitate the sealing resin 8 applied to the light emitting apparatus 1 according to the present invention.

In this process, the fluorescent material 9 and the precipitation-prevention agent 10 which are contained in the sealing resin 8 are agitated or mixed in the sealing resin 8 to uniformly disperse therein. It is preferable to defoam the sealing member in a vacuum furnace (not shown) to remove any air bubbles occurring in the sealing resin 8. The fluorescent material 9 and the precipitation-prevention agent 10 are uniformly dispersed in the sealing resin 8 by the agitating process, and the fluorescent material 9 is prevented from being precipitated in the sealing resin 8 by the precipitation-prevention agent 10 during operation of manufacture before resin cure.

Even if the sealing resin 8 is left alone for a long time after agitation, there is almost no precipitation of the fluorescent material 9 due to the effect of the precipitation-prevention agent 10. Consequently, whether the processes following an application process of the sealing resin 8 mentioned below are executed just after the mixing or agitating processes of the sealing resin 8, or whether they are executed after a certain time has elapsed, there is almost no change in the state of distribution of the fluorescent material 9 and the precipitation-prevention agent 10 contained in the sealing resin 8.

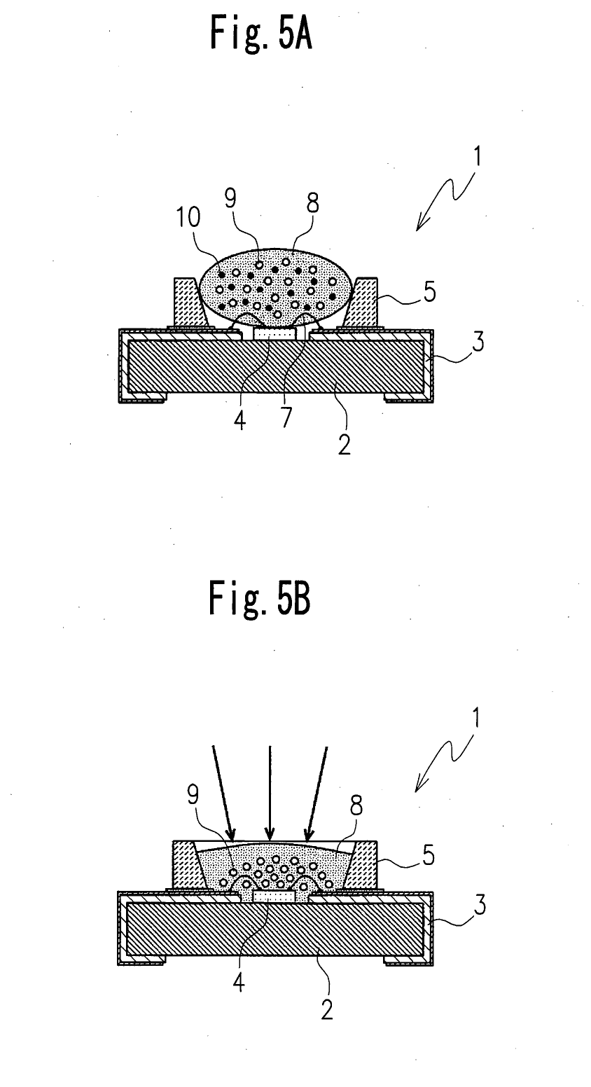

Next, FIG. 5A illustrates the process to apply the sealing resin 8 to seal the LED 4.

In this process, an interior of the cup 5 is filled with an appropriate amount of sealing resin 8. As mentioned above, the YAG type fluorescent material 9 and the fatty acid amide precipitation-prevention agent 10 are contained in the sealing resin 8.

Next, FIG. 5B illustrates a heating process to heat the sealing resin 8, thoroughly, and to harden it after the cup 5 has been filled with the sealing resin 8.

In the heating process, the sealing resin 8 applied to the interior of the cup 5 is heated to a temperature higher than the cure temperature of the sealing resin 8. Here, because the precipitation-prevention agent 10 contained in the sealing resin 8 starts to be affected by heat and to decrease its precipitation-prevention effect at a temperature lower than the hardening temperature of the sealing resin 8, as mentioned above, heat damage to the material of the precipitation-prevention agent 10 commences when a certain time has elapsed after the heating of the sealing resin 8.

Affected by heat, its precipitation-prevention effect is reduced or eliminated, and precipitation of the fluorescent material 9 commences in the vicinity of the LED 4 positioned at a bottom surface in the cup 5 filled with the sealing resin 8.

After a further certain time has elapsed, the heating of the sealing resin 8 has progresses. As progress in gelatinization and viscosity of the sealing resin 8 commences the fluorescent material 9 cease to precipitate. In this way, because the precipitation of the fluorescent material 9 depends on a heating temperature and duration of heating time, it is possible to control an amount of precipitation of the fluorescent material 9, by adjusting the heating temperature and the heating time in the heating process to cure the sealing resin. Control of the precipitation amount of the fluorescent material 9 is mentioned in detail hereinafter.

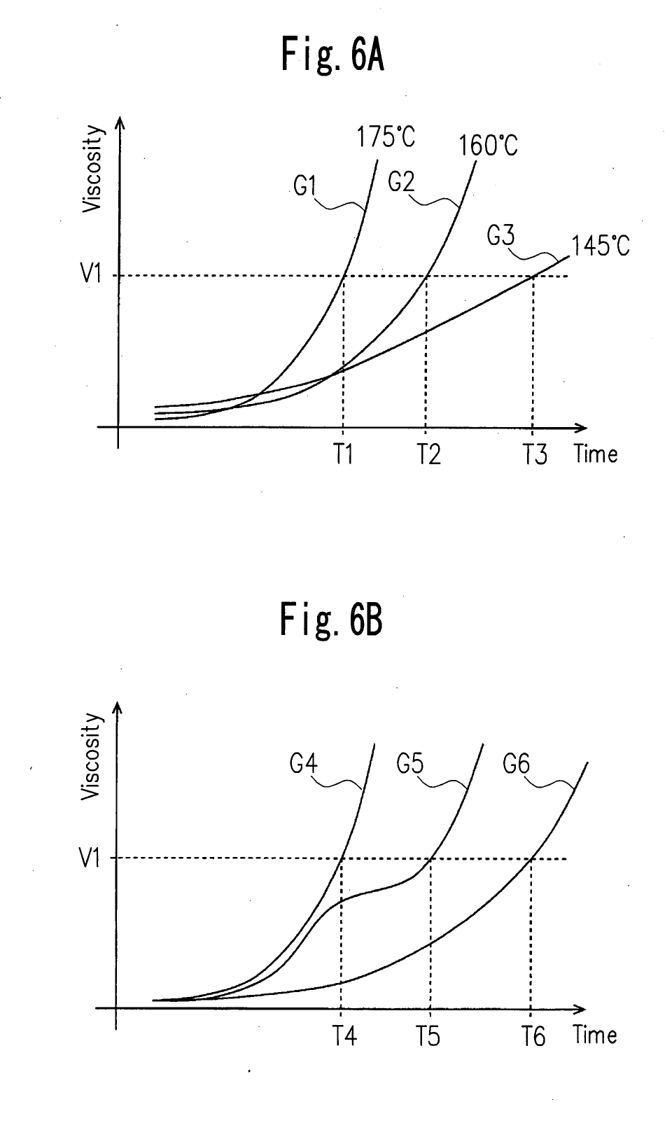

Next, control of the precipitated amount of the fluorescent material 9 contained in the sealing resin 8 is explained with reference to FIGS. 6A and 6B.

The amount of the fluorescent material 9 precipitated can be controlled by adjusting the heating temperature and the heating time in the heating process.

The way in which the amount precipitated is controlled by adjustment of the heating temperature is first explained referring to FIG. 6A.

An X axis in FIG. 6A shows a heating time to harden the sealing resin 8 in the heating process and a Y axis shows a viscosity of the sealing resin 8. In FIG. 6A, graph G1 shows a viscosity characteristic of the sealing resin 8 when heating the sealing resin 8 at about 175° C. to cure it. Also, graph G2 shows a viscosity characteristic of the sealing resin 8 when heating the sealing resin 8 at about 160° C. to cure it. Further, graph G3 shows a viscosity characteristic of the sealing resin 8 when heating the sealing resin 8 at about 145° C. to cure it.

Here, in graph G1, the heating temperature is highest so that the viscosity of the sealing resin 8 increases rapidly and the sealing resin 8 is hardened in a short time. Because the heating temperature in graph G2 is lower than that in graph G1, the viscosity increment of the sealing resin 8 in graph G2 is smaller than that of the sealing resin 8 in graph G1 so that curing of the sealing resin 8 is slower than in graph G1. Because the heating temperature in graph G3 is even lower than that in graph G2, the viscosity increment of the sealing resin 8 in graph G3 is smaller still than that of the sealing resin 8 in graph G2 so that curing of the sealing resin 8 is slower than that in graph G2.

In these graphs G1 to G3, if the point at which the fluorescent material 9 is no longer able to precipitate inside the sealing resin 8 due to increased viscosity of the sealing resin 8, that is to say, the point at which precipitation of the fluorescent material 9 ceases to precipitate is a viscosity V1, T1 in graph G1 reaches this viscosity V in the shortest time, T2 in graph G2 reaches in an intermediate time and T3 in graph G3 reaches in the longest time. Consequently, it is clear that a difference of T1 to T3 arises in the time used for the precipitation of the fluorescent material 9 until the precipitation being stopped, depending on a difference in the heating temperature to heat the sealing resin 8.

Here, if the effect-starting-to-decrease temperature of the precipitation-prevention agent 10 is 120° C., the precipitation-prevention agent 10 starts to be affected by heat and to decrease its precipitation-prevention effect when the sealing resin 8 reaches around 120° C. and precipitation of the fluorescent material 9 commences whatever the heating conditions in graphs G1 to G3. Thereby, the time difference in the times T1 to T3 to reach the above-mentioned viscosity V1 appears as a difference in the amount of the fluorescent material 9 precipitated. That is to say, in the heating conditions of graph G1, because the precipitated-elapsed time has the shortest value, the minimum amount of fluorescent material 9 is precipitated. In the heating conditions of graph G2, because the precipitated-elapsed time has an intermediate value, an intermediate amount of fluorescent material 9 is precipitated. In the heating conditions of graph G3, because the precipitated-elapsed time has the longest value, the maximum amount of fluorescent material 9 is precipitated.

Consequently, it is possible to control the precipitated amount of the fluorescent material 9 contained in the sealing resin 8 by adjusting the setting of the heating temperature in the heating process.

Next, control of the precipitated amount of the fluorescent material 9 by adjusting a heating time or inclination of temperature elevation at the same heating temperature is explained with reference to FIG. 6B.

An X axis in FIG. 6B shows a heating time to harden the sealing resin 8 in the heating process and a Y axis shows a viscosity of the sealing resin 8. In FIG. 6B, graph G4 shows a viscosity characteristic of the sealing resin 8 when heating the sealing resin 8 to reach a predetermined cure temperature in a short time. Also, graph G5 shows a viscosity characteristic of the sealing resin 8 when heating the sealing resin 8 by progressions until reaching a predetermined heating temperature. Further, graph G6 shows a viscosity characteristic of the sealing resin 8 when heating the sealing resin 8 slowly to reach a predetermined heating temperature over a somewhat longer time.

Here, in graph G4, the heating temperature is highest so that the viscosity of the sealing resin 8 increases rapidly and the sealing resin 8 is cured in a short time. Because the sealing resin 8 is heated by progressions in graph G5, the viscosity of the sealing resin 8 also increases by progressions, and the viscosity increment of the sealing resin is slower than in graph G4. Also, in graph G6, because the sealing resin 8 is heated slowly, the viscosity increment of the sealing resin 8 is even slower than in graph G5. In these graphs G4 to G6, if the point at which the fluorescent material 9 is no longer able to move inside the sealing resin 8 due to increased viscosity of the sealing resin 8, that is to say, the point at which the fluorescent material 9 ceases to precipitate is a viscosity V1, T4 in graph G4 reaches this viscosity V1 in the shortest time, T5 in graph G5 in an intermediate time and T6 in graph G6 in the longest time.

Consequently, it is clear that a difference of T4 to T6 arises in the time taken for the fluorescent material 9 to cease to precipitate, depending on a difference in the heating time or inclination of temperature elevation of the sealing resin 8, even if the cure temperature is fixed.

Here, if the cure temperature of the sealing resin 8 is set to, for example, 160° C. and the effect-starting-to-decrease temperature of the precipitation-prevention agent 10 is 120° C., the precipitation-prevention agent 10 starts to be affected by heat and to decrease its precipitation-prevention effect when the sealing resin 8 reaches around 120° C. However, the fluorescent material 9 precipitates under the heating conditions in graphs G4 to G6 before resin cure. Thereby, the time difference in the times T4 to T6 starting from precipitation precipitation of the fluorescent material to reaching the above-mentioned viscosity V1.

That is to say, in the heating conditions of graph G4, because the precipitated-elapsed time has the shortest value, the minimum amount of fluorescent material 9 is precipitated. In the heating conditions of graph G5, because the precipitated-elapsed time has an intermediate value, an intermediate amount of fluorescent material 9 is precipitated. In the heating conditions of graph G6, because the precipitated-elapsed time has the longest value, the maximum amount of fluorescent material 9 is precipitated.

Consequently, it is possible to control the precipitation amount of the fluorescent material 9 contained in the sealing resin 8 by adjusting the heating time in the heating process. Moreover, it is possible to further finely control the precipitated amount of the fluorescent material 9 contained in the sealing resin 8 by adjusting both the heating temperature and the heating time rather than by adjusting only one or the other of the heating temperature and the heating time in the heating process. Meanwhile, because the precipitation of the fluorescent material 9 depends on the viscosity of the sealing resin 8 and/or diameter of particles of the fluorescent material 9, it is preferable to take these conditions into consideration when adjusting the heating temperature and the heating time.

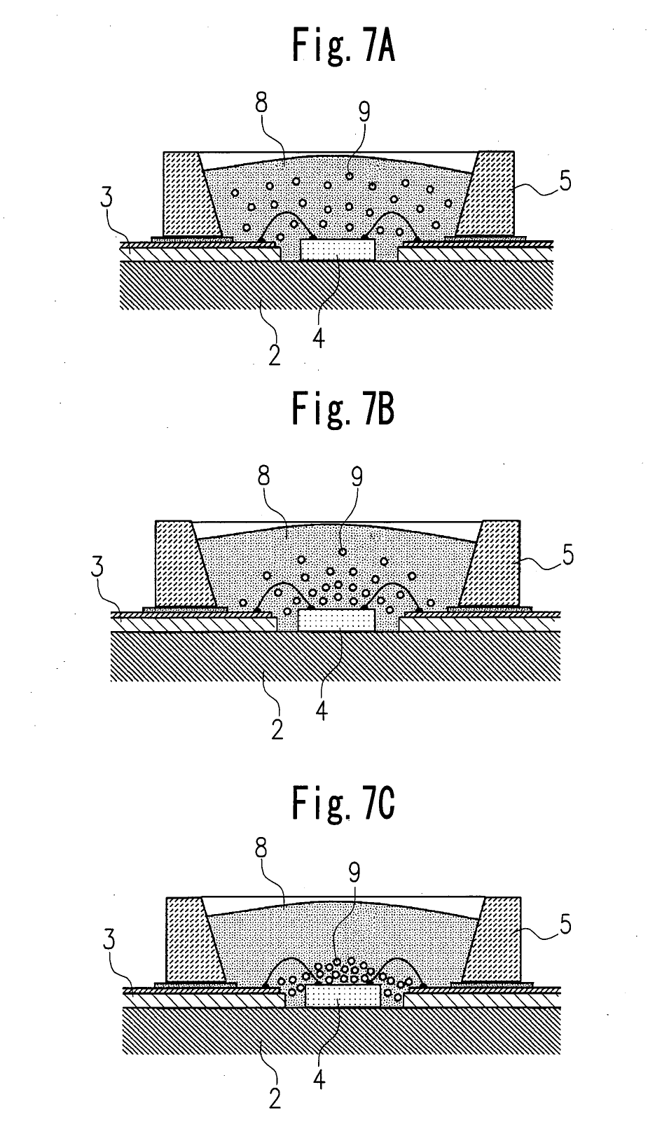

Next, a state of precipitation of the fluorescent material 9 contained in the sealing resin 8 in the light emitting apparatus 1 according to the present invention is explained with reference to FIGS. 7A to 7C.

Here, the fluorescent material 9 is contained and uniformly dispersed in the sealing resin 8. The cup 5 of the light emitting apparatus 1 is filled with the sealing resin 8 which is cured in the heating process. The fluorescent material 9 starts to precipitate toward the LED 4 mounted on the bottom surface of the cup 5 when the material of the precipitation-prevention agent 10 starts to be affected by heat and to decrease its precipitation-prevention effect. Next, when the heating proceeds and the sealing resin 8 begins to harden, precipitation of the fluorescent material 9 may be stopped by completing the resin cure. at a point when a certain amount of precipitation has already occurred and the fluorescent material 9 has a state of precipitation as shown in FIGS. 7A to 7C.

Here, FIG. 7A illustrates a state in which hardening of the sealing resin 8 is conducted rapidly, a small amount of the fluorescent material 9 is precipitated and the fluorescent material 9 is fairly evenly dispersed within the sealing resin 8. In this case, a relatively smaller proportion of light emitted from the LED 4 strikes the fluorescent material 9 due to the way the fluorescent material is dispersed, and hence the conversion efficiency of the wavelength of the light by the fluorescent material 9 is limited to a low value. A high proportion of converted light strikes the fluorescent material 9 again because of the fluorescent material 9 being dispersed throughout the entire sealing resin 8, and brightness of the light emitting apparatus is therefore reduced.

FIG. 7B illustrates a state in which the sealing resin has an appropriate hardening time and the fluorescent material 9 is adequately precipitated in the vicinity of the LED 4. In this case, an adequate proportion of the light emitted from the LED 4 strikes the fluorescent material 9 because the fluorescent material 9 is adequately dispersed in the vicinity of the LED 4 in the sealing resin 8; therefore there is an effective wavelength conversion for the light due to the adequately dispersed fluorescent material 9, and as a result, the light emitting apparatus has high brightness.

FIG. 7C illustrates a state in which the fluorescent material 9 precipitates and is accumulated in the vicinity of the LED 4, because the sealing resin 8 has a longer time for resin cure. In this case, a large part of the light emitted from the LED 4 strikes the fluorescent material 9 and is wavelength-converted. Because a high proportion of the light in which the wavelength has already been converted strikes the fluorescent material 9 again and is blocked by the accumulated fluorescent material 9, the light emitting apparatus has low brightness. In this way, because the wavelength conversion efficiency of the light emitting apparatus 1 varies significantly depending on the state of precipitation of the fluorescent material 9 contained in the sealing resin 8, it is necessary to adequately control the precipitation amount of the fluorescent material 9.

Here, in the light emitting apparatus 1 according to the present invention, the precipitation-prevention agent 10 which starts to be affected by heat and to decrease its precipitation-prevention effect at a temperature is contained in the sealing resin 8 together with the fluorescent material 9 and prevents the fluorescent material 9 from precipitating within the sealing resin 8. Moreover, the application of heat to the sealing resin 8 to cure it causes the precipitation-prevention agent 10 to starts to be affected by heat and to decrease its precipitation-prevention effect inside the sealing resin 8 and this allows precipitation of the fluorescent material 9 to commence.

In addition, continued heating of the sealing resin 8 causes it to be cured and the fluorescent material 9 to ceases to precipitate. The present invention makes it possible to achieve an appropriate degree of precipitation of the fluorescent material 9 as shown in FIG. 7B, by adjusting the heating temperature and the heating time in the cure process of the sealing resin 8, as mentioned above.

Consequently, because the fluorescent material 9 contained in the sealing resin 8 to seal the LED 4 is prevented from precipitating by the precipitation-prevention agent 10 which starts to be affected by heat and to decrease its precipitation-prevention effect, and the precipitation amount of the fluorescent material 9 is controlled by the heating temperature and the heating time of the sealing resin 8, a stable light emitting apparatus with high brightness can be provided. Also, it is known that the larger the particulate diameter of the fluorescent material 9 becomes, the higher the wavelength conversion efficiency becomes. And, because the light emitting apparatus according to the present invention allows control of precipitation amount of the precipitation-prevention agent and it is possible to use such fluorescent material with a large particulate diameter which enables to enhance the wavelength conversion efficiency.

Because the material of the precipitation-prevention agent 10 starts to be affected by heat and to decrease its precipitation-prevention effect with the heating of the sealing resin 8, emission light or converted light which passes through the sealing resin 8 is not attenuated or reflected by the precipitation-prevention agent 10. Consequently, it is possible to provide a light emitting apparatus which emits light with excellent wavelength conversion efficiency and luminous efficiency, and with high brightness. In addition, because precipitation of the fluorescent material 9 is prevented by the precipitation-prevention agent 10 contained in the sealing resin 8, there is almost no variation in the state of dispersion of the fluorescent material 9 in the sealing resin 8, whether a long or short time may depend on the heating process of the sealing resin 8. It is therefore possible to supply a plurality of products which have stable characteristics without any variations in emission color or emission brightness caused by differences in elapsed times during the working process.

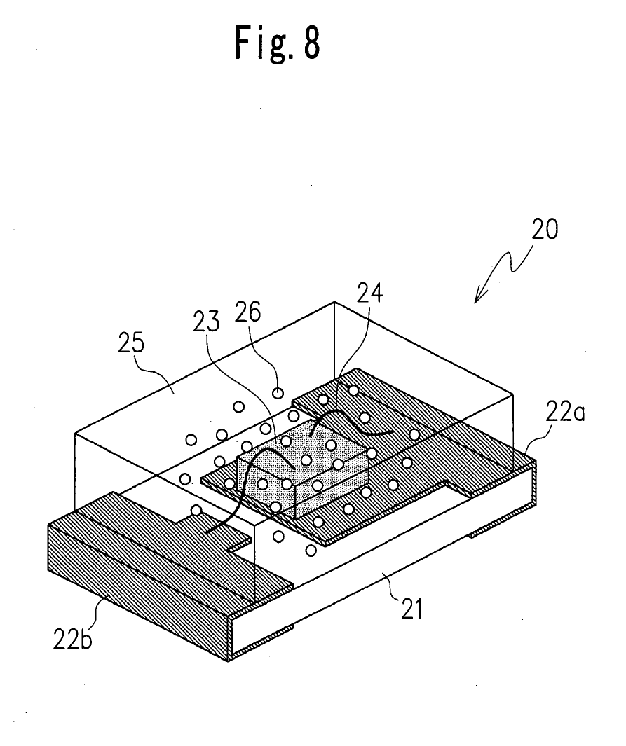

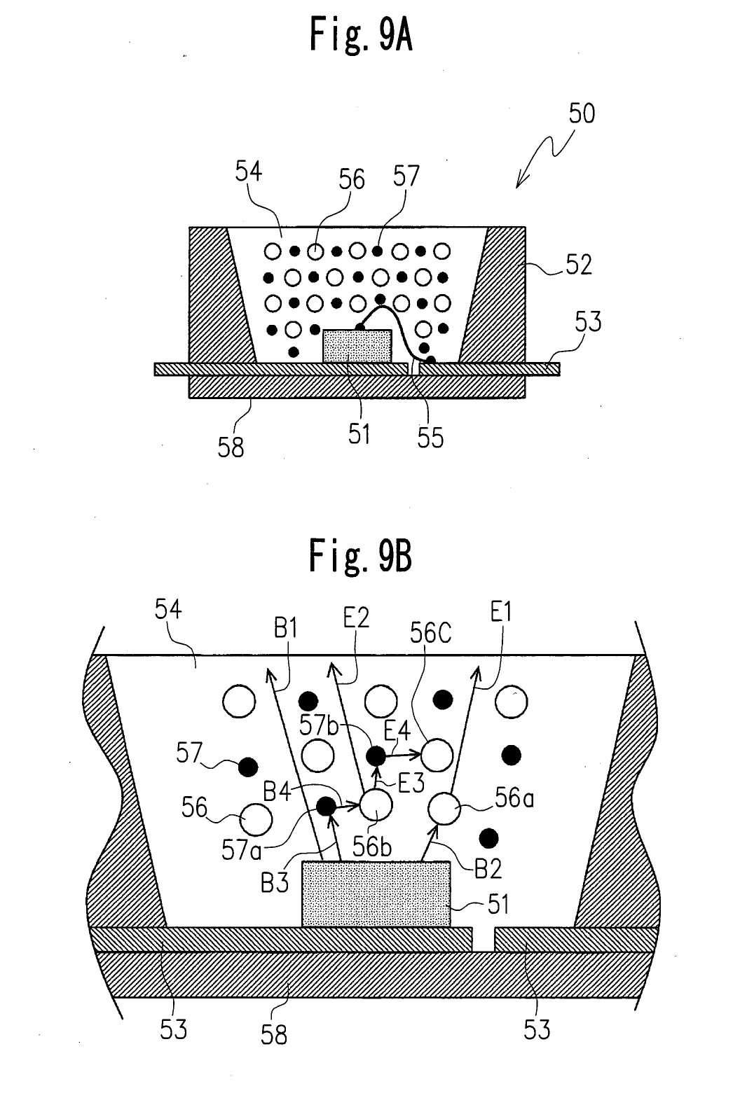

Next, a second embodiment of the light emitting apparatus according to the present invention is explained with reference to FIG. 8.

The light emitting apparatus in the second embodiment is realized as a thin light emitting apparatus in which a resin is applied directly onto a base on which a light emitting element is mounted. The light emitting apparatus 20 in the second embodiment includes an insulative base 21 which has a generally rectangular solid-like shape and is formed by, for example, an epoxy material or the like. A pair of electrodes 22a and 22b each of which is formed by a copper film are provided on a surface of the base 21 to cover a portion of an upper surface of the base 21, and a portion of the right and left side surfaces and a lower surface of the base 21 (see FIG. 8). In this embodiment an LED 23 which acts as the light emitting element is die-mounted on the electrode 22a formed on the upper surface of the base 21 through, for example, a conductive adhesive (not shown) preferably with a heat conducting capability or solder (not shown).

A pair of wires 24 which act as electrical connecting members connect an anode terminal (not shown) and a cathode terminal (not shown) of the LED 23 to the electrodes 22a and 22b, respectively. It should be noted that the electrical connecting members to connect the LED 23 and the electrodes 22a, 22b are not limited to the wires 24, and the LED 23 may, for example, be connected to the electrodes 22a and 22b through a face-down bonding system using soldering bumps or the like.

A sealing resin 25 made of, for example, an epoxy material or the like is provided on the upper surface of the base 21 to seal the LED 23 and so on, thus protecting them physically and chemically.

A fluorescent material 26 of YAG type functioning as a wavelength conversion material to convert a wavelength of light emitted from the LED 23 is contained in the sealing resin 25. It should be noted that any material, such as a fluorescent dye, fluorescent pigment, fluorescent substance or the like, may be used for the fluorescent material 26, as long as it is a material which converts the wavelength of the light from the LED 23 into another wavelength.

A precipitation-prevention agent which is made of a fatty acid amide is contained in the sealing resin 25, similarly to the first embodiment. Because the precipitation-prevention agent starts to be affected by heat and to decrease its precipitation-prevention effect when the sealing resin 25 is heated to harden it, it is omitted from FIG. 8.

Because operation of the light emitting apparatus 20 is similar to that in the first embodiment and a method for producing the light emitting apparatus is also basically the same, a description of the operation and method of production in the second embodiment is omitted. Because a method for controlling a precipitation amount of the fluorescent material 26 contained in the sealing resin 25 and effect of the fluorescent material 26 are also similar to those in the first embodiment, a description thereof is omitted.

It should be noted that the light emitting apparatus according to the present invention is not limited to the forms and configurations shown in the first and second embodiments. For example, provided that the wavelength conversion material and the precipitation-prevention agent having an effect-starting-to-decrease temperature are contained in the sealing resin to seal the LED 23 and that it is possible to control the precipitation amount of the wavelength conversion material through heating of the sealing resin, the invention can be applied to a light emitting apparatus of any form.

According to the present invention as mentioned above, because the precipitation-prevention agent with an effect-starting-to-decrease temperature is contained in the sealing resin to seal the light emitting element, it is possible to control the precipitation amount of the wavelength conversion material to convert the wavelength of the light emitted from the light emitting element in the sealing resin, thereby achieving a high wavelength conversion efficiency. In addition, because the material of the precipitation-prevention agent starts to be affected by heat and to decrease its precipitation-prevention effect when the sealing resin is heated, there is no blocking of the passage of light emitted from the light emitting element, and it is thereby possible to provide a light emitting apparatus with stable characteristics and high brightness, in which variations in emission color or emission brightness are reduced.

Moreover, the sealing resin is configured so as to be cured at a cure temperature which is greater than the effect-starting-to-decrease temperature of the precipitation-prevention agent and so seal the light emitting element together with the wavelength conversion material. Thereby, because the sealing resin is heated at a temperature higher than the effect-starting-to-decrease temperature of the precipitation-prevention agent in order to harden it, the material of the precipitation-prevention agent starts to be affected by heat and to decrease its precipitation-prevention effect with that heating, and, having been affected by heat, it ceases to function as a precipitation-prevention agent, and precipitation of the wavelength conversion material commences. With further continuation of the heating, the sealing resin becomes hardened and the wavelength conversion material ceases to precipitate. Thereby, the precipitation amount of the wavelength conversion material in the sealing resin can be controlled by adjusting the heating temperature or the heating time of the sealing resin, or both thereof.

It is therefore possible to achieve a suitable degree of precipitation of the wavelength conversion material and so provide a light emitting apparatus with excellent wavelength conversion efficiency and high brightness.

Furthermore, the precipitation-prevention agent is of a fatty acid amide and is configured so as to melt at an effect-starting-to-decrease temperature lower than the cure temperature of the sealing resin. Because the precipitation-prevention agent is made of a fatty acid amide, it begins to be affected by heat and to decrease its precipitation-prevention effect at a heating temperature of around 120° C., following which precipitation of the wavelength conversion material occurs. Accordingly, it is possible to adequately control the amount of the wavelength conversion material precipitated.

In addition, because the material of the precipitation-prevention agent starts to be affected by heat and to decrease its precipitation-prevention effect with the heating, the emission light or converted light passing through the sealing resin is prevented from being attenuated or reflected. It is therefore possible to achieve a light emitting apparatus with excellent emission efficiency and wavelength conversion efficiency, and with high brightness.

Although the preferred embodiments of the present invention have been mentioned, it should be noted that the present invention is not limited to these embodiments, and various modifications, changes and variations can be made to the embodiments.

What is claimed is:

1. A light emitting apparatus, comprising:
a light emitting element; and
a resin sealing the light emitting element,
a wavelength conversion material to convert at least one portion of light emitted from the light emitting element to a different wavelength and a precipitation-prevention agent being contained in the resin,
the precipitation prevention agent being in the resin for controlling precipitation of the wavelength conversion material by use of difference between a cure temperature of resin and an effect-starting-to-decrease temperature of the precipitation prevention agent.

2. The light emitting apparatus according to claim 1,
wherein the resin hardens at the cure temperature higher than or equal to the effect-starting-to-decrease temperature of the precipitation-prevention agent.

3. The light emitting apparatus according to claim 1,
wherein precipitation of the wavelength conversion material is promoted by decreasing the precipitation-prevention effect.

4. The light emitting apparatus according to claim 2,
wherein the precipitation-prevention agent is made of a fatty acid amide and decreases precipitation-prevention effect at a temperature lower than or equal to the cure temperature of the resin.

5. A method for producing a light emitting apparatus, comprising:
a process for mounting a light emitting element on a base and electrically connecting the light emitting element and the base;
a process for including a wavelength conversion material to convert at least one portion of light emitted from the light emitting element to a different wavelength and a precipitation-prevention agent having an effect-starting-to-decrease temperature lower than a cure temperature of a resin;
a process for agitating the wavelength conversion material and the precipitation-prevention agent which are contained in the resin;
a process for applying the resin so as to seal the light emitting element; and
a process for heating the sealing resin at a temperature greater than the effect-starting-to-decrease temperature of the precipitation-prevention agent for a predetermined time to seal the light emitting element and control an amount of the wavelength conversion material precipitated.

6. The method for producing a light emitting apparatus according to claim 5,
wherein the amount of the wavelength conversion material precipitated is controlled by adjusting a heating temperature and a heating time in the heating process.
